(19) United States
(12) Patent Application Publication
(10) Pub. No.: US 2017/0308359 A1
(43) Pub. Date: Oct. 26, 2017

(54) AUTOMATIC SCRIPT GENERATION

(71) Applicants: Sonam SINGH, Bangalore (IN); Shalini C, Bangalore (IN); Senthil Kumar R, Chennai (IN); HEWLETT PACKARD ENTERPRISE DEVELOPMENT LP, Houston, TX (US)

(72) Inventors: Sonam SINGH, Bangalore (IN); Shalini C, Bangalore (IN); Semthil Kumar R, Chennai (IN)

(73) Assignee: HEWLETT PACKARD ENTERPRISE DEVELOPMENT LP, Houston, TX (US)

(21) Appl. No.: 15/510,628

(22) PCT Filed: Nov. 3, 2014
(86) PCT No.: PCT/IN2014/000709

§ 371 Date: Mar. 10, 2017

(51) Int. Cl. G06F 9/44; G06F 9/455

(52) U.S. Cl. CPC G06F 8/22; G06F 8/33; G06F 9/45512

(57) ABSTRACT

An example embodiment of automatic script generation includes receiving input describing a task to be performed by a script. The input may be analyzed, and at least one option corresponding to the task may be outputted. Code may be embedded in the script based on a selected option.

### BACKGROUND

A script (as the term is used in the computer science arts) is a program that supports programming languages written for a particular run-time environment. Scripts may be referred to as “high-level programming,” because scripts often execute at a high level of abstraction.

Scripts interpret (as opposed to compile) and automate execution of tasks that would otherwise have to be executed manually by a person. As such, scripts enable automated environments, increase efficiency and can lower the costs associated with manual labor. By way of example, scripts can be used for the deployment, monitoring, and upgrading of hardware and/or software environments, executing various functions on a web page (e.g., within a web browser), tasks associated with the operation system (OS) shell, and functions within embedded systems (e.g., firmware).

### BRIEF DESCRIPTION OF THE DRAWINGS

FIG. 1 is a high-level illustration of an example computer system which may be implemented for automatic script generation.

FIGS. 2A-C are block diagrams of example architectures of computer-readable instructions, which may be executed for automatic script generation.

FIGS. 3A-F are graphical user interface (GUI) renditions illustrating examples of automatic script generation.

FIGS. 4A-B are flowcharts illustrating example operations which may be implemented for automatic script generation.

### DETAILED DESCRIPTION

Automatic script generation is disclosed. In an example, a method of automatic script generation comprises receiving input describing a number of tasks and a description of the task(s) to be performed by a script when executed by a computing device. The input may be analyzed, and at least one option output corresponding to the task. The options may be generated as the user types, and may include “matches” of tasks which may be applicable. The user may select from these options. After receiving a user-selection from the at least one option, code is embedded in the script which is executable by a processor of the computing device.

A computer program product and tool are also disclosed, as these may be embodied as computer-readable instructions stored on a non-transient computer-readable medium. When executed by a processor, input describing a task to be performed by a script is analyzed, and options are presented for a user to select from. The options may be generated as the user types, and may include “matches” of tasks which may be applicable. The user may select from these options, and corresponding code to execute the task for the selected option is embedded in the script.

In an example, the scripting language (e.g., VB Script or PowerShell) may be selected (e.g., by a user or other entity). After selecting the desired scripting language, a user is prompted to enter a number of tasks for the script to execute, and a corresponding number of search boxes are dynamically generated. The user may begin typing (e.g., a text string) defining the task. As the user types, a database is searched for corresponding tasks, which are presented to the user as options from which to make a selection. This avoids the user mistyping the task (e.g., ensures proper syntax) and speeds script generation (e.g., a task is identified before the user has finished typing the task). Additional input (e.g., checkboxes) may also be provided, for example to enable various conditions for performing a task during execution of the script and/or various sub-tasks (e.g., enable/disable logging).

By way of non-limiting illustration, a computer technician may desire to generate a script to automate one or more repetitive tasks that are to be performed on multiple computing devices in a network environment. For example, the computer technician may want to check each computer and determine whether Microsoft Office® is installed, and if present, uninstall this user application and instead install a newer version or alternative application (e.g., Open Office).

Using the tool described herein, the computer technician (i.e., the user in this case) may first select a scripting language (e.g., VB Script). The user is then requested to select a number of tasks to be performed by the script. In this example, three tasks are to be performed, i.e., 1) check if Microsoft Office® is installed, 2) if present then uninstall, and 3) install Open Office. Accordingly, the user selects three from the number of tasks (e.g., in a dropdown menu), and in response, three search boxes are displayed. In the first text box, the user may begin typing “Check installed application.” As the user types, the search box itself (or an area adjacent the search box) displays options which may be a good match for the task being entered by the user. For example, the search box may display “Check installed application” as soon as the user types “Check ins[]” (where [] represents the position of the cursor). As soon as the user sees the appropriate option (i.e., in this example “Check installed application”), the user can make a selection. Upon selecting the option “Check installed application,” another text box may appear, listing applications which can be checked for installation. This process repeats for each of the tasks. Then the user may click “Generate Script” or similar, and the tasks are processed using task repository. The task repository includes semantics and code based upon the task to be performed, which can then be directly embedded in the script to automatically generate and output the script. The user (or other entity) can then deploy the script to the appropriate computing devices for execution.

Before continuing, it is noted that as used herein, the terms “includes” and “including” mean, but are not limited to, “includes” or “including” and “includes at least” or “including at least.” The term “based on” means “based on” and “based at least in part on.”

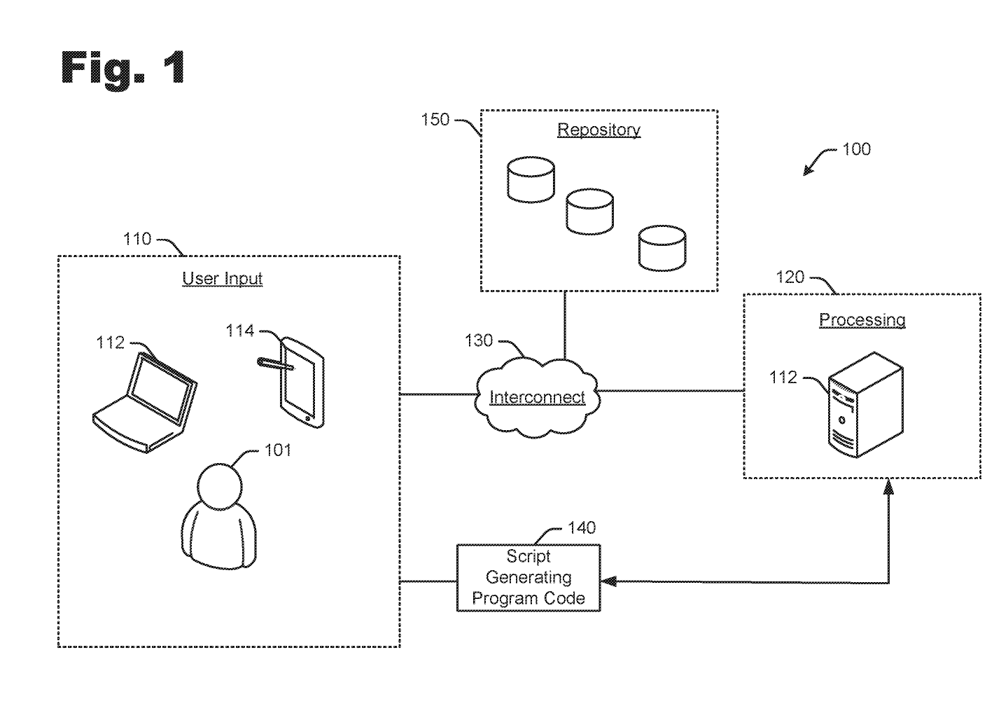

FIG. 1 is a high-level illustration of an example computer system 100 which may be implemented for automatic script generation. System 100 may be implemented with any of a wide variety of computing devices, such as, but not limited to, personal computers, mobile devices, workstations, server computer environments, and appliances (e.g., devices dedicated to providing a service), to name only a few examples. The computing devices implemented in the user input environment 110 (e.g., laptop 112 or tablet 114) of system 100, as well as those included in the processing environment 120 (e.g., server 122) may include memory or storage, and a degree of data processing capability at least sufficient to manage a communications connection or interconnect 130 either directly with one another or indirectly (e.g., via a network). At least one of the computing devices is also configured with sufficient processing capability to execute the program code described herein.

In the example shown in FIG. 1, the system 100 is shown as it may be deployed in a distributed environment (e.g., network or “cloud” based), wherein the user input environment 110 is shown as being distinct and separate from the processing environment 120. In such an environment, the script generating program code 140 may be hosted by the server 122 and accessed, e.g., via an “app” on the user devices 112 and 114. Furthermore, a repository 150 including data for the program code 140 is shown hosted separate and apart from the user input environment 110 and the processing environment 120. As such, the repository 150 may be readily updated without requiring an update of the program code 140 and/or the computing devices.

It is noted, however, that the script generating program code is not limited to deployment in any particular computing environment. For example, the program code 140 may be deployed directly on the user devices 112 and 114 and/or for use exclusively on a server computer 122. Likewise, the repository 150 may be included with the program code 140 or otherwise stored on a computing device executing the program code 140.

In addition, it is noted that the computing devices are not limited in function. The computing devices may also provide other services in the system 100. For example, host 110 may also provide transaction processing and other application services.

The repository 150 may include any suitable data and/or other content for generating the script as disclosed herein. For example, the repository 150 may include databases or other data store for providing information for analyzing user input (described in more detail below) and/or code (or “snippets” of code) which may be embedded in a script based on the user input. There is no limit to the type or amount of data that may be provided by the repository 150. In addition, the content may include unprocessed or “raw” data, or the content may first undergo at least some level of processing before being available in the repository 150.

In an example, the program code 140 may be executed to analyze input describing a task to be performed by a script that is to be generated. The program code may also be executed to present at least one option for a user corresponding to the task, and upon selection of the appropriate option, to embed code in the script and thereby automatically generate a script.

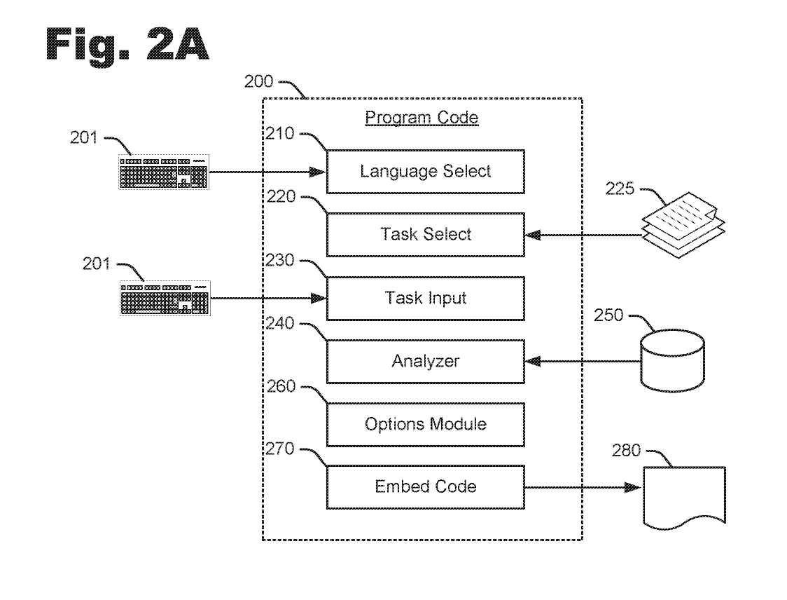

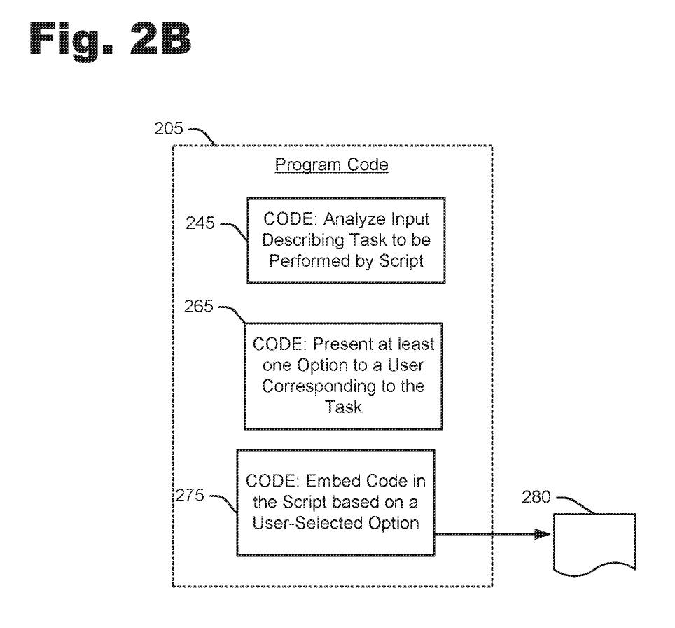

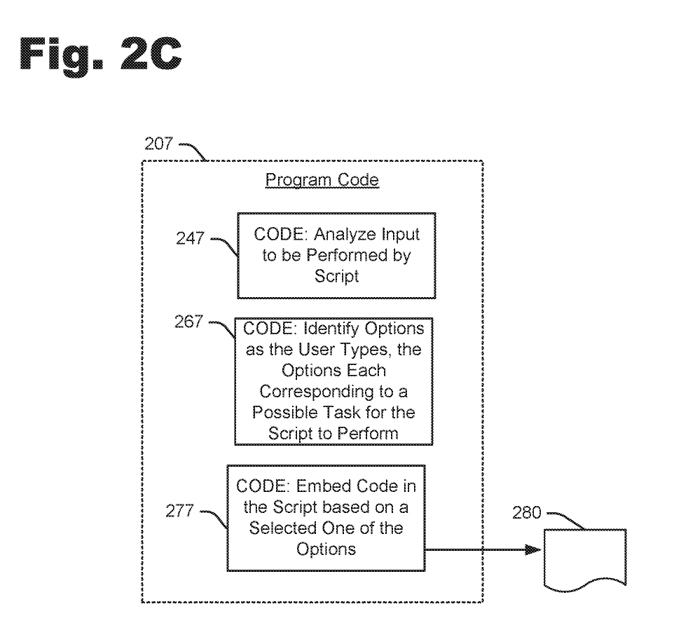

Program code used to implement features of the system can be better understood with reference to FIGS. 2A-C and the following discussion of various example functions. However, the operations described herein are not limited to any specific implementation with any particular type of program code.

FIGS. 2A-C are block diagrams of example architecture of computer-readable instructions, which may be executed for automatic script generation. In an example, the program code discussed above with reference to FIG. 1 may be implemented in computer-readable instructions (such as, but not limited to, software or firmware). The computer-readable instructions may be stored on a non-transient computer-readable medium and are executable by one or more processors to perform the operations described herein. It is noted, however, that the components shown in FIGS. 2A-C are provided only for purposes of illustration of an example operating environment, and are not intended to limit implementation to any particular system.

The program code executes the function of the architecture of computer-readable instructions as self-contained modules. These modules can be integrated within a self-standing tool, or may be implemented as agents that run on top of an existing program code.

FIG. 2A illustrates an architecture 200 of computer-readable instructions. The architecture 200 may include a language select module 210. The language select module 210 provides a selection of supported a coding languages for generating a script. The selection of supported coding languages may be dynamic. That is, coding language(s) may be added and/or removed from the selection of supported coding languages over time. It is noted that any suitable coding language may be selected for generating the script. In an example, the coding language may be selected by a user, as illustrated by the keyboard 201 in FIG. 2A. In an example, the coding language may be preselected, or the options at least limited in some regard (e.g., based on user permissions or other parameters). In an example, the coding language may be at least in part selected automatically and user-selected. In an example, the coding language may be pre-selected (e.g., based on platform type or other device parameters), and is not provided as a user option to select a coding language.

In an example, the architecture 200 of computer-readable instructions may include a task select module 220. The task select module 220 may query the user (or other entity) as to a number of task(s) for the script. For purposes of illustration, the user may indicate that the script is to perform three tasks. Accordingly, the task select module 220 may generate an input window with three task search boxes (e.g., as illustrated by tasks 225), one for each of the proposed tasks. It is noted, however, any number of tasks may be selected for the script.

In an example, the architecture 200 of computer-readable instructions may include a task input module 230 and an analyzer 240. Task input module 230 may receive input from a user or other entity, as illustrated by keyboard 201. For purposes of illustration, a user may start typing text in a search box. This text describes the task to be performed by the script (e.g., “Check If Application Installed”). The user may start (albeit not be finished) typing a text string describing the task into the task search box. The analyzer 240 begins analyzing the input at any point. For example, the analyzer 240 may begin as soon as the user begins typing (or at some suitable point thereafter, e.g., at 2 or 3 characters typed). Based on the user input, the analyzer 240 searches a script class and object database 250 for functions defining the corresponding task (e.g., program code such as routines and subroutines).

In an example, the analyzer 240 may also analyze input by checking for variants of text search strings. Variants may include, but are not limited to, synonyms of commons search terms (e.g., Check=Confirm=Verify), different ordering of words in a text string, abbreviations, omission of terms in a text string, and misspellings of words.

In an example, the architecture 200 of computer-readable instructions may include an options module 260. The options module 260 may also output options (or potential matches) corresponding to the task (and/or a condition for performing the task) as described in task search box. Any number of potential matches may be displayed for the user, and the potential matches may be displayed for the user in any suitable format (e.g., in a pop-up window, another user space, a drop down box). In an example, the potential matches found during the search may further be provided to generate a list of potential subtasks for the task, and/or potential conditions related to the task (e.g., conditions for performing the task). It is noted that the number of options may be constrained such as to not overwhelm the user (e.g., by presenting a long list of options). For example, the number of potential matches may be constrained to “top three” or other predefined constraint. In another example, the subtasks and/or conditions may be identified if the user selects a +(“plus”) operator to expand the list.

The user may continue typing in task search box until the desired task is displayed in the second user space. For example, the user may continue typing until the entire task has been described in task search box, or the user may stop typing at some time prior to completing the text string. For example, the user may select the potential match (e.g., by clicking on potential match) as soon as the user sees the desired task being displayed as an option. When the user selects the potential match, the task description is populated into the task search box, and the process may repeat with the next task to be described. In an example, the user may have an option to go back and edit and/or change task descriptions before generating the script.

The options module 260 may also present the user with options for completing the text string, e.g., by specifying the name and/or type of application to be inserted into the task description. Other options may include, but are not limited to, requesting the user to specify a condition for executing the task (e.g., if an error occurs more than three times), a time for executing the task (e.g., install after midnight), and/or other parameter(s) for executing the task. Other options may also include asking the user to specify (or select from among) one or more potential subtask and/or potential condition to be performed for the task.

In an example, the architecture 200 of computer-readable instructions may include an embed code module 270. After all of the tasks have been entered, the embed code module 270 may enter a script generate phase. The embed code module 270 may then execute to generate and output a script 280, for example, by embedding code in the script 280. For example, embedding program code may be based on parameters in the setup phase (e.g., coding language) and input phase (e.g., task definitions). The script 280 may be provided as output for a user or directly to another entity (e.g., another computing device).

FIG. 2B illustrates an example architecture 205 of computer-readable instructions which may be executed for automatic script generation. It is noted that the modules correspond to modules shown in FIG. 2A. For example, instructions 245 corresponds to module 240, instructions 265 corresponds to module 260, and instructions 275 corresponds to module 270.

In an example, instructions 245 may be executed to analyze input describing a task to be performed by a script. Instructions 265 may be executed to present at least one option to a user corresponding to the task. Instructions 275 may be executed to embed code in the script 280 based on a user-selected option.

FIG. 2C illustrates an example architecture 207 of computer-readable instructions which may be executed for automatic script generation. It is noted that the instructions correspond to modules shown in FIG. 2A. For example, instructions 247 corresponds to module 240, instructions 267 corresponds to module 260, and instructions 277 corresponds to module 270.

In an example, instructions 247 may be executed to analyze input to be performed by a script. Instructions 267 may be executed to identify options as the user types, the options each corresponding to a possible task for the script to perform. Instructions 277 may be executed to embed code in the script based on a selected one of the options.

Before continuing, it should be noted that the examples described above are provided for purposes of illustration, and are not intended to be limiting. Other devices and/or device configurations may be utilized to carry out the operations described herein.

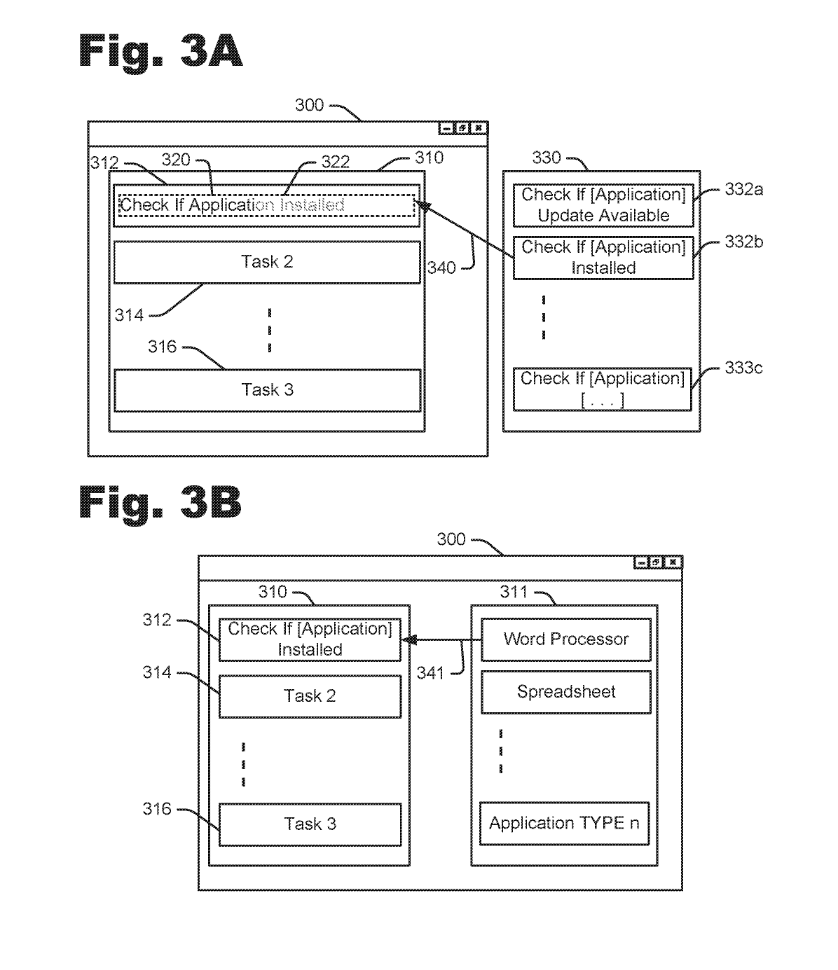

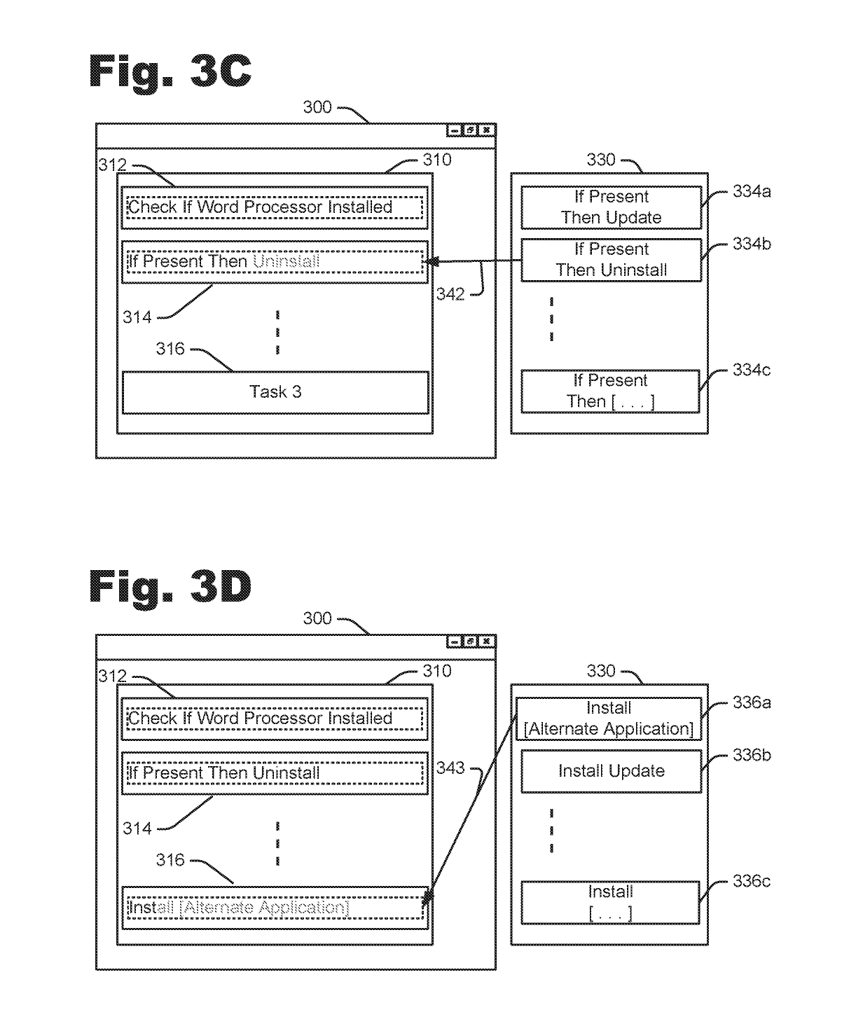

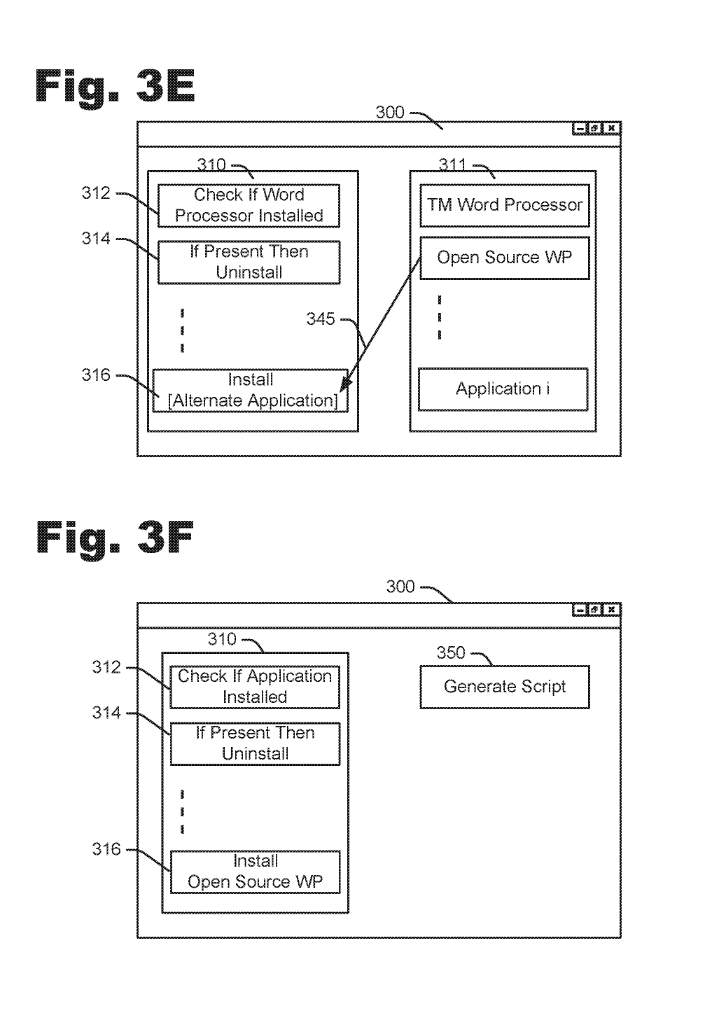

FIGS. 3A-F are graphical user interface (GUI) renditions illustrating examples of automatic script generation. The operations are illustrated as the output generated may be displayed using an end-user interface (device based or web-based interface). In an example, the end-user is able to make predetermined selections, and the program code executes to present output to a user.

It is noted that FIGS. 3A-F illustrate a portion of the interaction described herein. For example, in this illustration the user has already selected a coding language for generating a script, and has already selected a number of tasks for the script. It is noted that any suitable coding language may be selected for generating the script, and in an example, it is not an option to select a coding language.

In the illustration shown, the user has indicated that the script is to perform three tasks. Accordingly, the program code has generated a window 300 having a first user space 310 with three task search boxes 312, 314, and 316, one for each of the proposed tasks. However, any number of tasks may be selected for the script.

The program code may execute to receive input, e.g., from a user or other entity. In this illustration, a user has started typing text in search box 312 (i.e., “Check If Application Installed”). This text describes the task to be performed by the script. It is noted that in this illustration, the user has started (albeit not finished) typing the task, as illustrated by darker font type 320 shown up to the position of the cursor in FIG. 3A. That is, the user has typed the text string “Check If Applicati[].” The program code begins analyzing the input at any point. For example, the analysis may begin as soon as the user begins typing (or at some suitable point thereafter, e.g., at 2 or 3 characters typed).

Based on the user input, the program code searches a script class and object database 330 based on the task to be performed, and outputs options (or potential matches 332a-c) corresponding to the task being described in task search box 312, as illustrated by arrow 340. A search box may be dynamically populated with an option as the user types a text string describing the task to be performed by the script. For example, one of potential matches 332a-c may be displayed in the text box, as illustrated by a gray font type 322 in FIG. 3A completing the text string “Check If Application Installed.”

Any number of potential matches may be displayed, e.g., below the text box with the closest match displayed in the text box itself, and other likely options below the text box. In an example, the number is constrained such as to not overwhelm the user. For example, the number of potential matches displayed for a user may be constrained to “top three” or other predefined constraint.

The user may continue typing in task search box 312 until the desired task is displayed in the second user space 330. For example, the user may continue typing until the entire task has been described in task search box 312, or stop at some time prior. In FIG. 3A, the user sees “Check If Application Installed” is displayed as a potential match 322. The user may select potential match 322, e.g., by clicking on potential match 322. When the user selects the potential match 322, the task description is populated into task search box 312, as illustrated in FIG. 3B.

In this example, the text [Application] is provided in brackets, meaning that the user has to (e.g., may be prompted to) make a selection as to the type and/or name of application. In FIG. 3B, a second user space 311 is displayed including a number of applications from which the user may make a selection. In the example shown in FIG. 3B, generic names such as “Word Processor,” “Spreadsheet,” and “Application TYPE n” are shown for purposes of illustration. However, it is understood that commercial names of applications (e.g., MS Word®” may be displayed in user space 311. Here, the user is shown selecting “Word Processor,” as illustrated by arrow 341 in FIG. 3B.

The interaction described above with reference to FIG. 3B illustrates completing the text string, in this example, by specifying the name and/or type of application to be inserted into the task description. It is noted that other interactions with the user may also occur, such as but not limited to requesting the user to specify a condition for executing the task (e.g., if an error occurs more than three times), a time for executing the task (e.g., install after midnight), and/or other parameter(s) for executing the task. Other interactions may also include asking the user to specify (or select from among) one or more subtasks and/or conditions to be performed for the task. It is noted that these interactions may be presented to the user as illustrated in FIG. 3B, or otherwise, such as but not limited to, radio buttons, check boxes, another search box for entering text, etc.

The process repeats for the second task (Task 2), using task search box 314 as illustrated in FIG. 3C. In this illustration, a user has started typing text in search box 314 (i.e., “If Present Then Uninstall”). Again, the text describes the task to be performed by the script. The user has started (albeit not finished) typing the task, as illustrated by the dark font (i.e., “If Present Then”) shown in FIG. 3C. The program code begins analyzing the input, and based on the user input, the program code searches a script class and object database 330 for the task to be performed, and outputs options (or potential matches 334a-c) corresponding to the task being described in task search box 314, as shown displayed by the gray font (i.e., “Uninstall”). In the illustration shown in FIG. 3C, potential matches 334a-c including a matching text string (e.g., “If Present Then . . . ”) are searched.

The user may continue typing in task search box 314 until the desired task is displayed. In FIG. 3C, the user sees “If Present Then Uninstall” is displayed as a potential match. The user may select the potential match, e.g., by clicking on potential match. When the user selects the potential match 334b, the task description is populated into task search box 314, as illustrated by arrow 342.

The process repeats for the second task, using task search box 316 as illustrated in FIG. 3D. In this illustration, a user has started typing text in search box 316 (i.e., “Install Alternate Application”). It is noted that the generic term “Alternate Application” is used for purposes of illustration, but this may be an application specified by name (e.g., Open Source Word Processor).

Again, the text describes the task to be performed by the script, and the user has started (albeit not finished) typing the task, as illustrated by the darker font (i.e., “Inst”) in FIG. 3D. The program code begins analyzing the input, and based on the user input, the program code searches a script class and object database and outputs options (or potential matches 336a-c) corresponding to the task being described in task search box 316, as shown displayed by the gray font (i.e., completing the text string “Install [Alternate Application]).

The user may continue typing in task search box 316 until the desired task is displayed in the second user space 330. In FIG. 3D, the user sees “Install Alternate Application” is displayed as a potential match. The user may select the potential match, e.g., by clicking on potential match in the search box 316. When the user selects the potential match, the task description is populated into task search box 316, as illustrated by arrow 343 in FIG. 3D.

The text [Alternate Application] is shown to the user in brackets, meaning that the user has to make a selection as to the type and/or name of the application. In FIG. 3E, a second user space 311 is displayed including a number of applications from which the user may make a selection. In the example shown in FIG. 3E, “TM Word Processor” (e.g., for a brand name or trademarked Word Processor application) is displayed, along with “Open Source WP” for an open source version of the word processor. Here, the user is shown selecting “Open Source WP,” as illustrated by arrow 345 in FIG. 3E.

After all of the tasks have been entered, e.g., as illustrated in FIGS. 3A-E, the program code may enter a script generate phase. In an example, the user may have an option to go back and edit and/or change task descriptions before entering the script generate phase. In the illustration shown in FIG. 3F, the user selects a Generate Script button 350 when the user is ready to continue. The program code may then execute to generate and output a script, for example, by embedding code in the script. For example, embedding program code may be based on parameters in the setup phase (e.g., coding language) and input phase (e.g., task definitions). The script may be provided as output for a user or directly to another entity (e.g., another computing device).

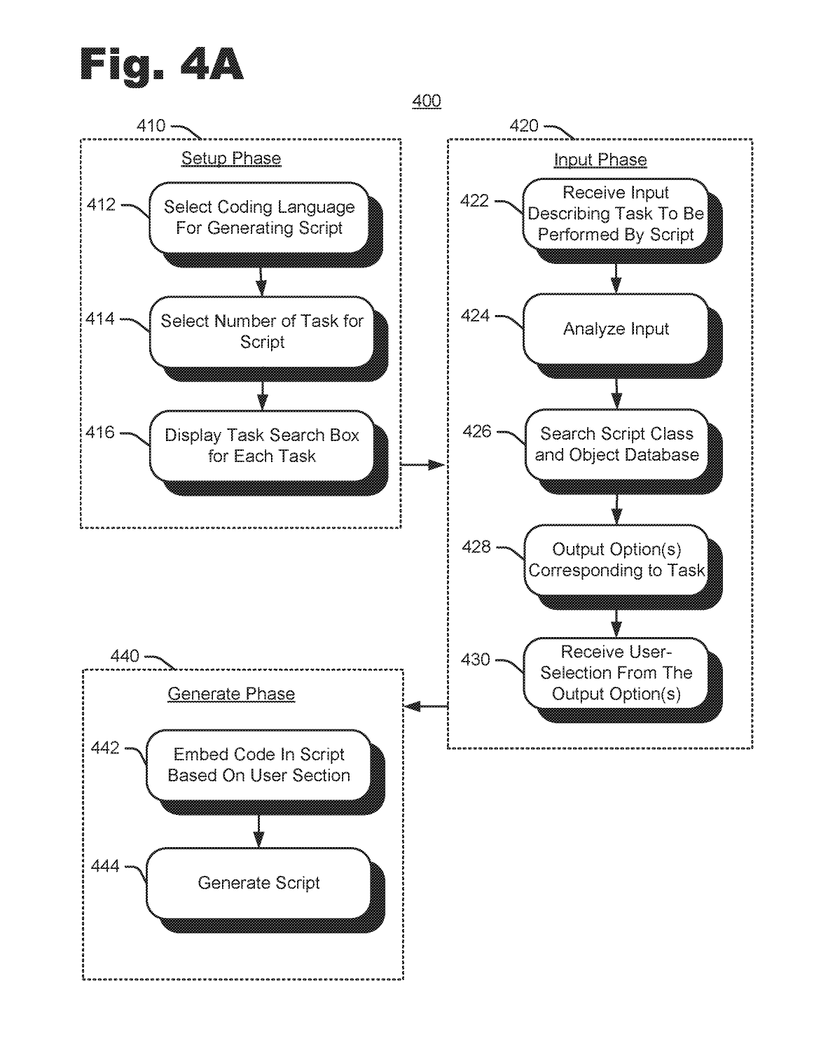

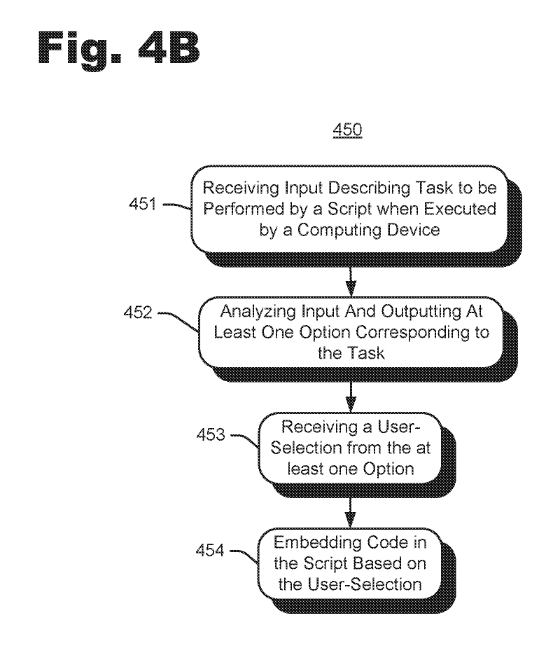

FIGS. 4A and 4B are flowcharts illustrating example operations which may be implemented for automatic script generation. Operations 400 and 450 may be embodied as logic instructions on one or more non-transitory computer-readable media. When executed by a processor, the logic instructions cause a general purpose computing device to be programmed as a special-purpose machine that implements the described operations. In an example, the components and connections depicted in the figures may be used.

The operations may be implemented at least in part using an end-user interface (e.g., device-based or web-based interface). In an example, the end-user is able to make predetermined selections, and the operations described below are implemented by a computing device to process the computer-readable instructions and present results to a user. The user can then make further selections. It is also noted that various operations described herein may be automated or partially automated.

FIG. 4A illustrates example operations 400 for a setup phase 410, an input phase 420, and a generate phase 440. In an example setup phase 410, the program code may execute to setup interaction with the user, e.g., via a user interface such as the graphical user interface (GUI) illustrated in FIGS. 3A-D. Operation 412 includes selecting a coding language for generating a script. It is noted that any suitable coding language may be provided. Operation 414 includes selecting a number of tasks for the script. For example, the user may indicate that the script is to perform three tasks. However, any number of tasks may be selected for the script. Operation 416 includes displaying a task search box for each task.

In an example input phase 420, the program code may execute to receive input, e.g., from a user or other entity. Operation 422 includes receiving input describing the task to be performed by the script. For example, the user may type a description of a task (e.g., “Check If Application Install”). Operation 424 includes analyzing the input. By way of illustration, the program code may execute to analyze the letters being typed by the user in operation 422. In an example, analyzing the input includes checking for variants of text search strings, such as, but not limited to, searching for plurals, typographical errors, and shorthand notations.

Operation 426 includes searching a script class and object database. For example, the program code may execute to begin searching as soon as the user begins typing (or at some suitable point thereafter, e.g., at 2 or 3 characters typed). Operation 428 includes outputting options corresponding to the task input at operation 422. For example, the program code may execute to return potential matches for the input received at operation 422. In some examples, the program code may execute to dynamically output at least one option as a user types the input describing the task to be performed by the script. Operation 430 includes receiving a user selection from the output options. For example, the user may select the option from among one or a plurality of options output in operation 428, the user's selection best matching the task to be performed.

In an example script generate phase 440, the program code may execute to generate and output a script. Operation 442 includes embedding code in the script. For example, embedding program code may be based on parameters in the setup phase (e.g., coding language) and input phase (e.g., task definitions). Operation 444 includes generating the script, e.g., as output for a user or other entity.

FIG. 4B illustrates example operations 450 of automatic script generation. In operation 451, the operations include receiving input describing a task to be performed by a script when executed by a computing device. In operation 452, the operations include analyzing the input and outputting at least one option corresponding to the task. In operation 453, the operations include receiving a user-selection from the at least one option. In operation 454, the operations include embedding code in the script based on the user-selection, the embedded code executable by a processor of the computing device.

The operations shown and described herein are provided to illustrate example implementations. It is noted that the operations are not limited to distinct phases (e.g., setup phase 410, input phase 420, and generate phase 440 in FIG. 4A), as these are shown only for purposes of illustration and clarity. It is further noted that the operations are not limited to the number or ordering described with reference to FIGS. 4A-4B. Still other operations and operation orders may also be implemented.

It is noted that the examples shown and described are provided for purposes of illustration and are not intended to be limiting. Still other examples are also contemplated.

1. A method of automatic script generation, comprising:
receiving input describing a task to be performed by a script when executed by a computing device;
analyzing the input and outputting at least one option corresponding to the task;
receiving a user-selection from the at least one option; and
embedding code in the script based on the user-selection, the embedded code executable by a processor of the computing device.

2. The method of claim 1, further comprising selecting a coding language for generating the script from a plurality of coding languages.

3. The method of claim 1, further comprising receiving as input a number of tasks to be performed by the script.

4. The method of claim 3, further comprising displaying a search box for each task to be performed, the search box configured to receive the input.

5. The method of claim 1, further comprising dynamically outputting the at least one option as a user types the input describing the task to be performed by the script.

6. The method of claim 1, further comprising searching, based on the input describing the task to be performed by the script, a script class and object database.

7. The method of claim 1, wherein analyzing the input includes checking for variants of text search strings.

8. A computer program product embodied as computer-readable instructions stored on a non-transient computer-readable medium and executable by a processor to:
analyze input describing a task to be performed by a script;
present at least one option to a user corresponding to the task; and
embed code in the script based on a user-selected option.

9. The computer program product of claim 8, wherein the processor is further executable to display a search box for each task to be performed, the search box configured to receive the input.

10. The computer program product of claim 8, wherein the processor is further executable to dynamically output the at least one option as a user types the input.

11. The computer program product of claim 8, wherein the processor is further executable to search, based on the input describing the task to be performed by the script, a script class and object database.

12. An automatic script generating tool, comprising computer-readable instructions stored on a non-transient computer-readable medium, the computer-readable instructions execute by a processor to:
analyze input to be performed by a script;
identify options as the user types, the options each corresponding to a possible task for the script to perform; and
embed code in the script based on a selected one of the options.

13. The automatic script generating tool of claim 12, wherein the computer-readable instructions execute by the processor to dynamically populate a search box with the option as a user types a text string describing the task to be performed by the script.

14. The automatic script generating tool of claim 12, wherein the computer-readable instructions execute by the processor to search a script class and object database for functions defining the tasks to be performed by the script.

15. The automatic script generating tool of claim 12, wherein the computer-readable instructions execute by the processor to generate a list of potential subtasks or potential conditions related to the task.
